(19) United States
(12) Patent Application Publication
(10) Pub. No.: US 2002/0195788 A1
(43) Pub. Date: Dec. 26, 2002

(54) Steerable in-line street ski

(76) Inventors: Tyler Tierney, Palatine, IL (US); Kurt Tierney, St. Charles, IL (US); Thomas A. Wozny, Roselle, IL (US); Nicholas Nanos, Roselle, IL (US); Luc Heiligenstein, Chicago, IL (US)

Correspondence Address: BARNES & THORNBURG, 2600 CHASE PLAZA, 10 LASALLE STREET, CHICAGO, IL, 60603

(21) Appl. No.: 10/068,196

(22) Filed: Feb. 4, 2002

Related U.S. Application Data
(60) Provisional application No. 60/266,725, filed on Feb. 5, 2001.

(51) Int. Cl. B62M 1/00; A63C 17/01

(52) U.S. Cl. 280/87.042; 280/842

(57) ABSTRACT

A street ski comprising an elongated platform, a pair of trucks and a pair of wheels. Each truck includes a wheel support pivotably associated with the elongated platform and a spring connected to the wheel support for resisting pivoting of the wheel support relative to the elongated platform. Each wheel is rotatably mounted to the wheel support in any suitable manner such as by an axle or the like. In a preferred embodiment, the wheel support comprises a pair of fork members engaged with the axle. The truck permits rotation of the wheel support relative to the elongated platform in response to a shift in the weight of the rider of the board to simulate, for example, a snowboarding effect. The wheel supports desirably are raked in opposite directions to facilitate a fishtail effect or to otherwise facilitate a carving effect. Each truck includes a base rigidly secured to the elongated platform rotatably associating the wheel support with the elongated platform. The spring desirably engages the wheel support and the base for resisting pivoting of the wheel support relative to the base. In a preferred embodiment, the spring comprises an elastomer having a substantially cylindrical configuration. Each truck may further include a housing that desirably receives the spring, and the springs can be readily removed and replaced with springs of different resistance to affect the performance characteristics of the street ski. In another embodiment, the elongated platform may comprise a front, middle, and rear section, the upper surface of the middle section, to which the skier's foot is bound, is lowered relative to the front and rear sections, placing the skier's foot closer to the street surface and more closely simulating the feel of an actual snow or water ski.

The present invention relates to the field of street skis, and specifically to steerable street skis with in-line wheels. Priority is claimed based on U.S. Patent Application No. 60/266,725 filed on Feb. 5, 2001.

### BACKGROUND

Four-wheeled street skis are well known in the art. For example, U.S. Pat. No. 4,460,187 shows three- and four-wheeled street ski designs utilizing a forward wheel, a pair of intermediate wheels, and a single rear wheel or stopper. Usually, the orientation of each wheel relative to the elongated platform of the street ski is fixed, making it difficult to steer the street ski or to make turns with a tight turning radius. Some designs have incorporated a pivoting front wheel, which permits some steering control, but does not simulate the ride and feel of an actual snow ski, particularly the ability to lean the ski to one side and the tendency of the rear of the ski to slide laterally. The ability to simulate such sensations often is difficult due to the limitations of the wheel assemblies associated with the street skis.

### SUMMARY

The present invention provides a street ski comprising an elongated platform, at least one truck and at least one wheel. The truck includes a wheel support pivotably associated with the elongated board and a spring connected to the wheel support for resisting pivoting of the wheel support relative to the elongated board. The wheel is rotatably mounted to the wheel support in any suitable manner such as by an axle or the like. In a preferred embodiment, the wheel support comprises a pair of fork members engaged with the axle.

The truck desirably has any suitable construction that permits pivoting of the wheel support relative to the elongated platform in response to a shift in the weight of the rider of the board to simulate the ride of actual snow skis. Preferably, the street ski includes a second wheel and a second truck that desirably is similar or identical to the other truck except the wheel supports may be raked in opposite directions to facilitate a fishtail effect or to otherwise facilitate a carving effect.

In a preferred embodiment, for example, each truck includes a base rigidly secured to the elongated board rotatably associating the wheel support with the elongated platform. The spring desirably engages the wheel support and the base for resisting pivoting of the wheel support relative to the base. The spring may have any suitable construction, but in a preferred embodiment, it comprises an elastomer desirably having a substantially cylindrical configuration.

Each truck may further include a housing that desirably receives the spring, and a lug shaft engaging the base and the housing. The lug shaft is rigidly secured to the base, and the housing is pivotably associated with the lug shaft. The lugshaft includes at least one outwardly-extending lug shaft spline and wherein the spring defines at least one keyway for receiving the lugshaft spline. The truck may further include an outer cylinder member associated with the housing and having at least one outer cylinder spline and the spring defines at least one keyway receiving the outer cylinder spline.

Desirably, the spring within each truck can be readily removed and replaced with another spring of different resistance to alter the ride and carve characteristics. In this regard, the truck may further include an end cap engaging the lug shaft to retain the spring within the housing, and a retaining clip releasably engaged with the end cap for retaining the spring within the housing.

The street ski in accordance with a preferred embodiment may be used on any hard surface such as, for example, a street, a sidewalk, a skate park or the like, or a driveway, or, in accordance with alternative embodiments may be used on a softer surfaces, such as, for example, grass, dirt, mountains, hills or the like. Although the street ski in the preferred embodiments, desirably simulates the sensation of snow skis, it may in accordance with alternative embodiments instead simulate other sensations such as, for example, water skiing.

Other objects, advantages and novel features of the present invention will become apparent from the following detail description of the drawings when considered in conjunction with the accompanying drawings.

### BRIEF DESCRIPTION OF THE DRAWINGS

FIG. 1 illustrates an in-line street ski with forward and rear trucks.

FIG. 2 is a top view of the street ski illustrating the pivoting action of the trucks that result from the skier shifting his weight to the left side of the ski (lower part of the figure).

FIG. 3 is a view of the street ski from the rear, illustrating the rear truck pivoting caused by the skier shifting his weight to the left.

FIG. 4 is an exploded view of the forward truck.

FIG. 5 and 6 illustrate the assembled truck with the board not shown.

FIGS. 7, 8, and 9 are section views of the truck indicated in FIG. 5.

FIG. 10 is a perspective view showing the lower surface of the base.

### DETAILED DESCRIPTION OF THE PREFERRED EMBODIMENTS

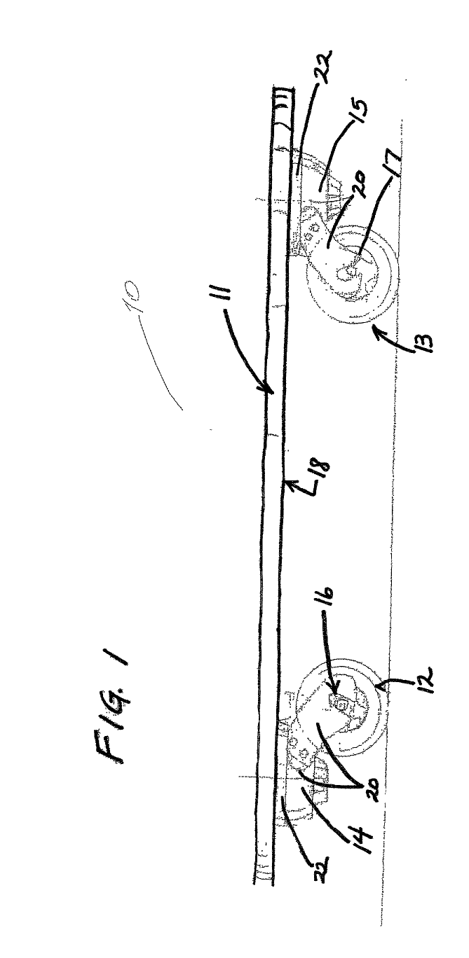

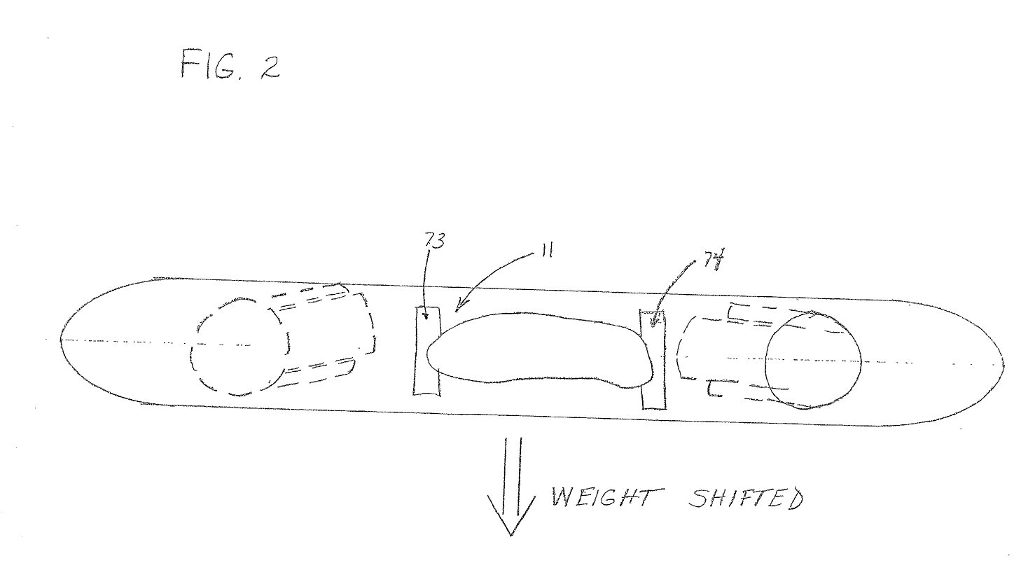

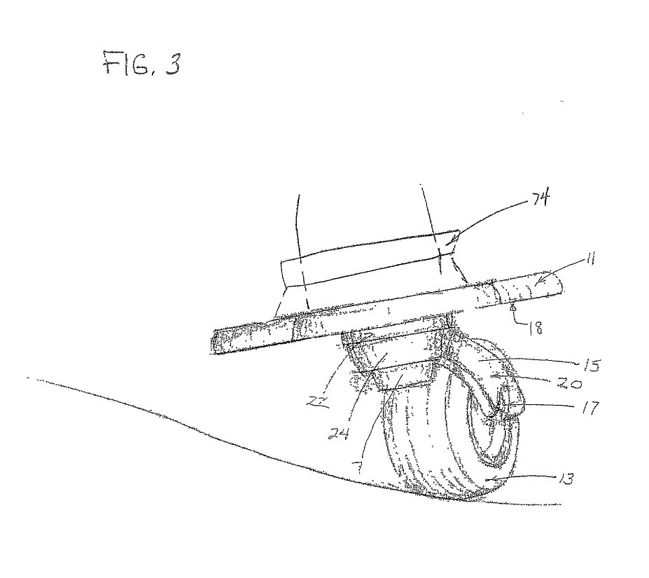

A street ski 10 in accordance with a preferred embodiment of the invention is illustrated in FIG. 1 as comprising an elongated platform 11, conventional bindings 73 and 74, two or more in-line wheels 12 and 13, trucks 14 and 15, and wheel axles 16 and 17 for mounting the wheels to the underside 18 of platform 11. The elongated platform 11 and in-line wheels 12 and 13 may have any suitable configuration and may be constructed of any suitable materials. Bindings 73 and 74, illustrated schematically in FIGS. 2 and 3, may be of any suitable design, preferably either molded rubber or mechanical devices, such as the rubber bindings typically used to secure a water skier's feet to the skis or mechanical bindings typically used to secure snow skiers' boots to snow skis.

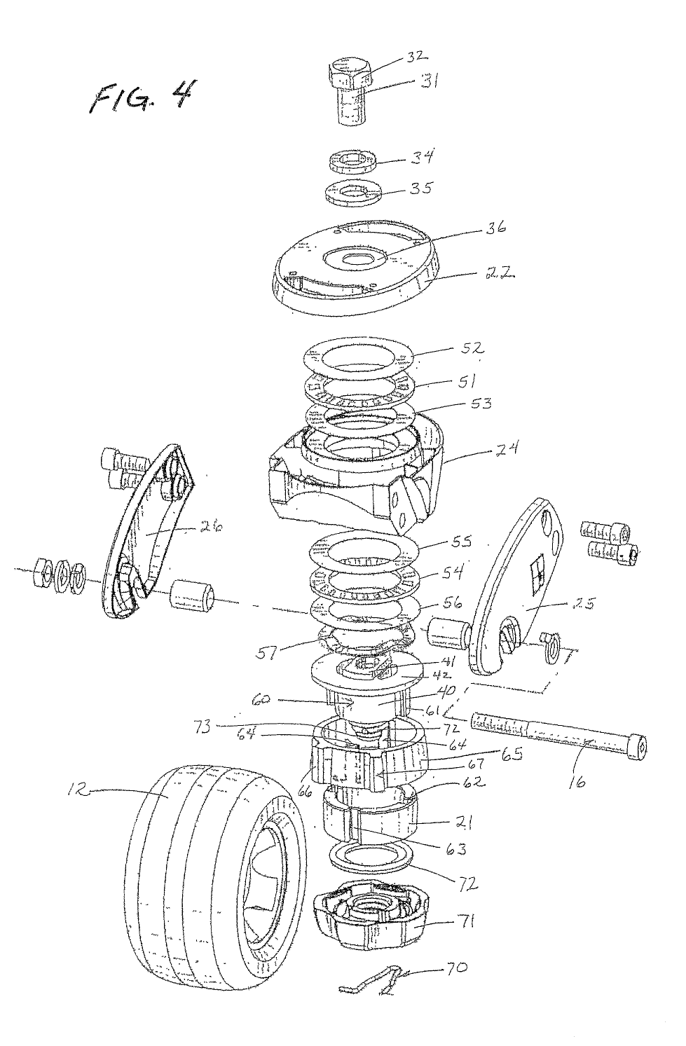

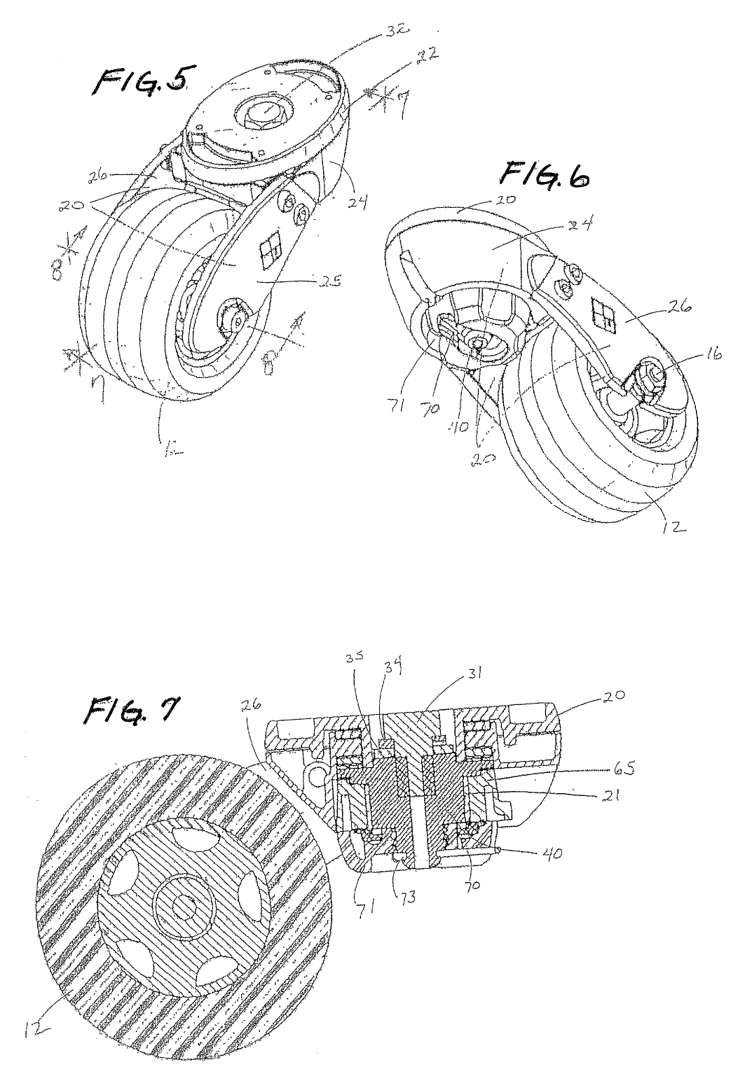

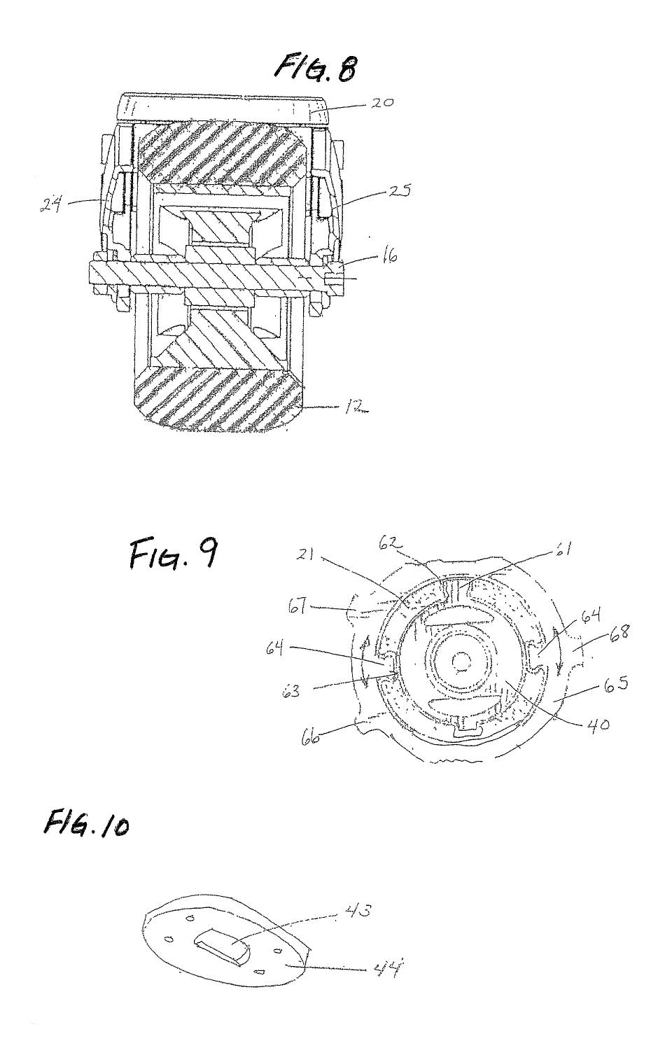

In a preferred embodiment, the trucks 14 and 15 have substantially identical constructions. Each truck 14 and 15 may, for example, be constructed as shown in FIGS. 4-9. Each truck 14 and 15 includes a wheel support 20 that is pivotably associated with the platform 11 in any suitable manner and a spring 21 for resisting rotating or otherwise pivoting movement of wheel support 20. In the illustrated embodiment, for example, each truck 14 and 15 further includes a base 22 rigidly secured to the underside 18 of the platform 11 by, for example, screws or bolts (not shown) passing through mounting holes defined by the base. Wheel support 20 desirably pivots relative to the elongated platform 11 and base 22.

The illustrated wheel support 20 may have any suitable construction. In the illustrated embodiment, for example, wheel support 20 comprises a housing 24 and a pair of fork members 25 and 26 that are raked, i.e., inclined from the vertical, so that the respective wheel axle 16 is not directly under the respective housing 24. In accordance with alternative embodiments, the offset may also be achieved by other means, such as extending the geometry of housing 24 or adding other intermediate parts, as long as wheel 12 is offset from the axis about which housing 24 pivots. Because of the offset, a side force on the wheel 12 (parallel to the wheel axle 16), is created when a rider leans to one side to tilt the platform, which causes housing 24 to pivot and wheel 12 to turn. A rearward rake on forward truck 14, i.e., placing the wheel 12 behind housing 24, causes the forward wheel 12 to turn and steer the platform in the direction the rider is leaning. A forward rake on rear truck 16, i.e., placing the wheel 13 ahead of housing 24, causes rear wheel 13 to turn in the direction opposite to direction the rider is leaning, also steering the platform in the direction the rider leans, but with a fishtail or lateral sliding effect as shown in FIG. 2.

Spring 21 resists the pivoting movement of housing 24 and desirably causes it to return to a center position when the side force on the wheel caused by the rider leaning is removed. Spring 21 may have any suitable construction and may be constructed of any suitable material. In a preferred embodiment, for example, spring 21 may have a hollow cylindrical configuration, such as, for example, the configuration illustrated in FIG. 4. The illustrated spring 21 desirably is made of an elastomer, preferably polyurethane. The spring 21 is interlocked with the housing 24 and base 22 by any of several known methods, including keys and keyways, splines, or a square shaft placed on the outside and inside surfaces of the hollow cylindrical spring.

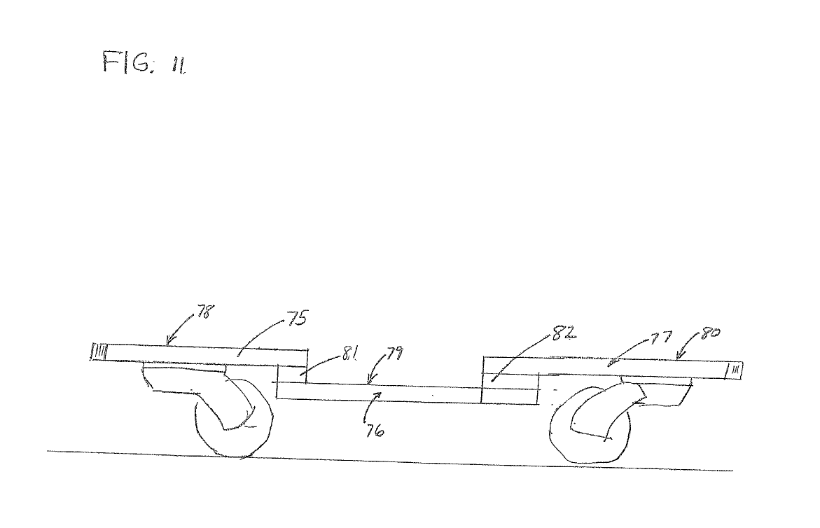

In the embodiment shown in FIGS. 4 through 9, bolt 31 descends through orifice 32 in base 22 such that the head 32 of bolt 32 rests on lock washer 34 and flat washer 35 which in turn rest on flange 36 of base 24. Bolt 31 threads into lug shaft 40. Lug shaft 40 has a rectangular protrusion 41 from the flange 42 which fits into a recess 43 in the lower surface 44 of base 22 shown in FIG. 10. This prevents lug shaft 40 from rotating relative to base 22.

Between lug shaft flange 42 and base 22 is housing 24. An upper thrust bearing 51 is positioned between housing 24 and base 22 to permit housing 24 to pivot relative to base 22 with minimal friction loss. Thrust washers 52 and 53 are placed between thrust bearing 51 and housing 24 and between thrust bearing 51 and base 22 respectively. Similarly, lower thrust bearing 54 and pair of thrust washers 55 and 56 are placed between housing 24 and lug shaft flange 42 to permit housing 24 to pivot with minimal friction relative to lug shaft 40 which as previously mentioned, does not move relative to base 22. A washer/bearing retainer 57 between the lower thrust washer 56 and lug shaft flange 42 keeps the upper and lower bearings and washers in compression.

Lug shaft 40 also has a middle cylindrical section 60 with one or more exterior splines 61. Exterior splines 61 are received by interior keyways 62 defined by spring 21. Spring 21 also defines one or more exterior keyways 63 to receive splines 64 extending inward from an outer ring 65. Outer ring 65 also has exterior stops 66, 67, and 68 that prevent it from rotating in housing 24. Consequently, as housing 24 turns, outer ring 65 is also turned through the outer ring stops 66, 67, and 68. Outer ring splines 64 are received by outer keyways 63 on spring 21 to transmit a torque to the spring 21. The movement of the inner keyways 62 on spring 21 is restricted, however, by splines 61 extending from lug shaft 40 which because of upper protrusion 41 and recess 43 cannot rotate relative to base 22. Thus, the side force on wheel 12 causes the housing 24 to pivot and the wheel 12 to turn, the amount of which depends on the stiffness of the material used for spring 21 and the positioning of the various keyways, which may geometrically limit the amount of spring deformation.

Outer ring 64 and spring 21 are held in place by a cap retainer 70 and threaded cap 71 which is threaded onto lug shaft threads 72 cut on the end of lug shaft 40. Once cap 71 is threaded onto the lug shaft threads 72, cap retainer 70 is snapped into a retaining ring groove 73 cut into the lower most end of the lug shaft 40, which protrudes beneath the cap 71, to prevent cap 71 from becoming unscrewed while the skateboard is in use. Spring 21 can be readily replaced with springs of different stiffness or elasticity by disengaging cap retainer 70 from the retaining ring groove 73 and unscrewing cap 71 from the lug shaft threads 72.

In other possible embodiments, the spring 21 could be replaced with a coiled torsional spring with one end of the spring attached to the outer cylinder and the other end of the spring attached to the lug shaft. An elastomer spring and coiled torsional spring could also be used in combination to achieve the desired restoring force as a function of wheel assembly pivoting. In yet another embodiment, the elastomer spring could comprise several sectors of a hollow cylinder that fit between splines 61 and 63.

In another embodiment, the elongated platform 11 of the ski may comprise a front section 75, a middle section 76, and a rear section 77, each with an upper surface 78, 79, 80, the front and middle sections being connected to each other, and the middle and rear sections connected to each other. In the alternate embodiment, the upper surface 79 of middle section 76, on which the skier's foot is secured by bindings 73 and 74, is lower than the upper surface of the front and rear sections. This configuration places the street skier's feet closer to the surface upon which the street skis are being ridden than is possible with a uniform elevation of the elongated platform due to the dimensions of the wheel assemblies. By placing the skiers feet close to the street surface, the street ski more closely simulates the feel of an actual snow or water ski. In this embodiment, the middle section 76 can be further lowered by placing a front spacer 81 between the front 75 and middle sections 76, and a rear spacer 82 between the middle 76 and rear sections 77 as shown in FIG. 11.

One feature of the aforementioned designs is that, if desired, the springs can be replaced to suit riders' preferences and to simulate the steering response of snow skis or waterskis as described above. In most cases, stiffer springs are preferred for more aggressive maneuvers and the rear truck springs are preferably stiffer than the forward truck springs.

Although the invention has been described and illustrated in detail with reference to preferred embodiments, it is to be clearly understood that the same is by way of illustration and example only, and is not to be taken by way of limitation.

We claim:

1. A street ski comprising:
an elongated platform;
a truck comprising:
a wheel support pivotably associated with the elongated platform;
an elastomer spring connected to the wheel support for resisting pivoting of the wheel support relative to the elongated platform; and
a wheel rotatably mounted to the wheel support.

2. The street ski of claim 1 wherein the truck includes a base rigidly secured to the elongated platform rotatably associating the wheel support with the elongated platform.

3. The street ski of claim 2 wherein the spring engages the wheel support and the base for resisting pivoting of the wheel support relative to the base.

4. The street ski of claim 1 wherein the spring has a substantially cylindrical configuration.

5. The street ski of claim 1, wherein the wheel support is raked, causing the wheel support to pivot in response to a shift in the rider's weight on the platform.

6. The street ski of claim 2 wherein the truck further includes:
a housing, and
a lug shaft engaging the base and the housing, the lug shaft rigidly secured to the base, the housing pivotably associated with the lug shaft.

7. The street ski of claim 6 wherein the spring has a substantially cylindrical configuration.

8. The street ski of claim 7 wherein the lugshaft includes at least one outwardly-extending lug shaft spline and wherein the spring defines at least one keyway for receiving the lugshaft spline.

9. The street ski of claim 7 wherein the truck further includes an outer cylinder member associated with the housing and having at least one outer cylinder spline and the spring defines at least one keyway receiving the outer cylinder spline.

10. The street ski of claim 7 wherein the spring is received within the housing.

11. The street ski of claim 10 wherein the truck further includes an end cap engaging the lug shaft to retain the spring within the housing.

12. The street ski of claim 11 wherein the truck further includes a retaining clip releasably engaged with the end cap for retaining the spring within the housing.

13. The street ski of claim 1 further including an axle and wherein the wheel support comprises a pair of fork members engaged with the axle, the wheel being mounted to the axle.

14. The street ski of claim 1, also comprising
a second truck comprising:
a second wheel support pivotably associated with the elongated platform; and
a second spring connected to the second wheel support for resisting pivoting movement of the second wheel support relative to the elongated platform; and
a second wheel rotatably mounted to the second wheel support.

15. The street ski of claim 14, wherein the second wheel support is raked, causing it to pivot in response to a shift in the rider's weight on the platform.

16. The street ski of claim 14, wherein the wheel support and the second wheel support are raked in opposite directions.

17. The street ski of claim 14 wherein the wheel support and the second wheel support each further include a pair of fork members and an axle engaged with the fork members, the wheel and the second wheel each being mounted to a respective axle.

18. A street ski comprising:
an elongated platform;
a truck comprising:
a base rigidly secured to the elongated platform;
a wheel support pivotably associated with the base;
an elastomer spring engaging the wheel support and the base for resisting pivoting of the wheel support relative to the base; and
a wheel rotatably mounted to the wheel support.

19. The street ski of claim 18 wherein the spring has a substantially cylindrical configuration.

20. The street ski of claim 19 wherein the truck further includes:
a housing receiving the spring, and
a lug shaft engaging the base and the housing, the lug shaft rigidly secured to the base, the housing pivotably associated with the lug shaft.

21. The street ski of claim 20 wherein the truck further includes an end cap engaging the lug shaft and a retaining clip releasably engaged with the end cap for retaining the spring within the housing.

22. The street ski of claim 18 wherein the wheel support is raked, causing the wheel support to pivot in response to a shift in the rider's weight on the platform.

23. A street ski comprising:
an elongated platform;
a pair of trucks, each truck comprising:
a base rigidly secured to the elongated platform;
a wheel support pivotably associated with the base;
a spring engaging the wheel support and the base for resisting pivoting of the wheel support relative to the base, the spring comprising a substantially cylindrical elastomer; and
a pair of wheels, each wheel rotatably mounted to a respective wheel support.

24. The street ski of claim 23 wherein each truck further includes a housing receiving the spring and a releasable retaining clip retaining the spring within the housing.

25. The street ski of claim 23 wherein the wheel supports are raked in opposite directions.

26. The street ski of claim 23, wherein the elongated platform comprises a front, a middle, and a rear section, the front section being connected to the middle section, which is connected to the rear section, where each section includes an upper surface, where the base of one of the trucks is rigidly secured to the front section and the base of the other truck is rigidly secure to the rear section, and where the upper surface of the middle section is lower than the upper surfaces of the front and rear sections.

27. The street ski of claim 26, wherein the elongated platform further comprises a front spacer placed between and connected to the front and middle sections.

28. The street ski of claim 27, wherein the elongated platform further comprises a rear spacer placed between and connected to the middle and rear sections.
